(19) United States
(12) Patent Application Publication
(10) Pub. No.: US 2014/0370412 A1
(43) Pub. Date: Dec. 18, 2014

(54) Charging Device for a Fuel Cell, in Particular of a Motor Vehicle

(71) Applicant: Daimler AG, Stuttgart (DE)

(72) Inventors: Siegfried Sumser, Stuttgart (DE); Andreas Knoop, Esslingen (DE); Paul Loeffler, Stuttgart (DE); Hans-Jörg Schabel, Reutlingen (DE); Benjamin Steinhauser, Bad Wurzach-Arnach (DE)

(21) Appl. No.: 14/362,021

(22) PCT Filed: Nov. 10, 2012
(86) PCT No.: PCT/EP2012/004675

§ 371 Date: May 30, 2014

(30) Foreign Application Priority Data
Dec. 1, 2011 (DE) 10 2011 119 881.8

(51) Int. Cl. H01M 8/04

(52) U.S. Cl. CPC H01M 8/04111; H01M 2250/20
USPC 429/446

(57) ABSTRACT

A charging device for a fuel cell includes a turbine having a housing part with a receiving chamber in which a turbine wheel of the turbine is received so as to be rotatable relative to the housing part about an axis of rotation. The turbine wheel includes impeller vanes via which a medium, in particular a gaseous waste gas of the fuel cell, can flow against the turbine wheel in an inlet region, and which are curved forwards at least in the inlet region.

### BACKGROUND AND SUMMARY OF THE INVENTION

Exemplary embodiments of the present invention relate to a charging device for a fuel cell, in particular for a motor vehicle.

German patent document DE 10 2010 026 909 A1 discloses a charging device for a fuel cell, wherein this fuel cell provides current for driving a motor vehicle by means of electric current, comprising a radial turbine having a housing part with a receiving chamber in which a turbine wheel of the turbine is received so as to be rotatable about an axis of rotation relative to the housing part. The turbine wheel comprises impeller vanes via which a medium, in particular a gaseous waste gas of the fuel cell, can flow against the turbine wheel in an inlet region.

PCT patent document WO98/02643A1 discloses a charging device for a fuel cell, comprising an axial turbine which has a housing part with a receiving chamber in which a turbine wheel of the turbine is received so as to be rotatable about an axis of rotation relative to the housing part. The turbine wheel comprises impeller vanes via which a medium, in particular a gaseous waste gas of the fuel cell in a power range up to 100 W, can flow against the turbine wheel in an inlet region, and which are designed so as to be completely curved forwards.

German patent document DE 2920479A1 discloses a charging device for an internal combustion engine, comprising a radial turbine which has a housing part with a receiving chamber in which a turbine wheel of the turbine is received so as to be rotatable about an axis of rotation relative to the housing part. The turbine wheel comprises impeller vanes via which a medium, in particular a gaseous waste gas of an internal combustion engine, can flow against the turbine wheel, and which are designed so as to be curved forwards in the outlet region.

German patent document DE 10 2008 007 616 A1 further discloses a Wells turbine with a hub to which a multiplicity of rotor blades is connected. The rotor blades have a symmetrical, drop-shaped profile that extends from a profile nose. The rotor blades also have a threading line, the course of which in the rotation plane of the Wells turbine deviates with respect to a radial beam associated with the respective rotor blade at least in parts from the radial extent of the rotor blade. In bearings of rotors of charging devices, for example, of exhaust gas turbochargers for internal combustion engines, axial forces occur which, for example, are absorbed by means of hydrodynamic axial bearings. Also, it is known to use antifriction bearings, in particular ball bearings, for mounting the rotors and for absorbing the axial forces. Such ball bearings, in particular in fast rotating rotors and at high axial forces and their fluctuations, have an unsatisfactory service life if no appropriate countermeasures are implemented.

It is also known from the prior art to provide motor vehicles with at least one fuel cell or a fuel cell device. The fuel cell device serves for providing electric current in order to drive the motor vehicle by means of the electric current.

Charging devices for such a fuel cell or fuel cell device can supply the fuel cell with a compressed medium, in particular compressed air, which results in a particularly efficient operation of the fuel cell or the fuel cell device. In this respect, a particularly efficient operation of the charging device is also of advantage.

Exemplary embodiments of the present invention are directed to a charging device for a fuel cell, in particular of a motor vehicle, which exhibits a particularly efficient operation.

Such a charging device for a fuel cell, in particular of a motor vehicle, comprises a housing part. The housing part has a receiving chamber in which a turbine wheel of a turbine of the charging device is received at least in part so as to be rotatable about an axis of rotation relative to the housing part.

The turbine wheel has impeller vanes via which a medium can flow against the turbine wheel in an inlet region and can drive it. The medium preferably is a gaseous waste gas of the fuel cell.

Here, the impeller vanes are designed so as to be curved forwards in the inlet region. By means of the forward curvature of the impeller vanes, the inlet region of the turbine wheel can be implemented in an aerodynamically large manner. Thus, the contribution of the turbine wheel to the occurring axial forces, and in particular the contribution of the turbine wheel to compensating the axial forces, which are caused in particular by a compressor of the charging device, can be given a very high weighting. In other words, it is possible to compensate the axial forces of the charging device at least partially by means of the forward curvature of the impeller vanes of the turbine wheel so that the load acting on a bearing, by means of which bearing the turbine wheel is mounted to be rotatable about the axis of rotation, is kept at a low level.

As a result, it is possible to configure the bearing according to the low load so that bearing losses of the bearing device according to the invention can be kept low. This results in an efficient operation of the charging device, which benefits an efficient operation of the fuel cell.

In particular, it is possible to use an anti-friction bearing, in particular a ball bearing, for mounting the turbine wheel such that the turbine wheel or a rotor of the charging device, which comprises the turbine wheel, a shaft that is connected to the turbine wheel in a rotationally fixed manner, and the compressor wheel that is connected to the shaft in a rotationally fixed manner, can be mounted with low loss.

Also, using the antifriction bearing is advantageous since in the charging device, at low turbine inlet temperatures in a range of ca. 80° C. to 120° C., a self-sufficient minimal quantity lubrication of the bearing or antifriction bearing can be implemented. This also allows the elimination of, at least almost completely, the introduction of lubricant into another medium, in particular air, with which the fuel cell is to be supplied by means of the charging device, and to implement energetically very advantageous mechanical efficiencies of the bearing. This is made possible with the charging device according to the invention while implementing at the same time a high service life of the bearing and therefore of the entire charging device since the load on the bearing can be kept low due to the at least partial compensation of the axial forces by means of the forward curvature of the impeller vanes.

Mounting the turbine wheel or the rotor by means of air suspension is advantageous in so far as, in contrast to ball bearings, no lubricant is required. The at least partially compensated axial forces are in particular beneficial for air suspension since the latter can support low axial forces.

The charging device according to the invention also provides for an efficient operation of the fuel cell since energy recovery to be carried out by means of the turbine of the charging device. The turbine can utilize waste gas emitted from the fuel cell. The waste gas drives the turbine wheel which, in turn, drives the compressor wheel via the shaft in order to supply the fuel cell with the compressed additional medium, in particular air.

Advantageously, the charging device comprises a guide vane cascade, in particular a variably adjustable guide vane cascade, which, in the flow direction of the medium, in particular the waste gas, is arranged upstream of the turbine wheel, in particular in the housing part. By means of the guide vane cascade, flow conditions and in particular inflow conditions of the turbine can be influenced for the medium. As a result, a back-pressure valve can be omitted, whereby the number of parts and the costs for the charging device can be kept low. Such a guide vane cascade and/or such a back-pressure valve ensure the implementation of an adjustable and effective narrowest flow cross-section of the turbine, as a result of which the charging device can be adapted to different operating points of the fuel cell. Thus, for example, a movement of the operating point in the compressor characteristics of the charging device towards the surge limit of the compressor at unsuitable pressures and air volume flow rates can be prevented.

The compressor and/or the turbine of the charging device are advantageously designed as a centrifugal compressor or a radial turbine by means of which the additional, at least substantially gaseous medium, in particular air, to be supplied to the fuel cell can be compressed efficiently and with little installation space required.

In an advantageous embodiment of the invention, a compensation element connected to the turbine wheel for at least partially compensating the axial forces as well as the compressor wheel rotatable about the axis of rotation are provided. The additional medium to be fed to the fuel cell can be compressed by means of the compressor wheel.

The compensation element can be acted upon at least in some regions via at least one channel by an outlet pressure of the additional medium to be compressed that prevails in the flow direction downstream of the compressor wheel.

By acting upon the compensation element by the outlet pressure, the axial forces can be compensated at least partially and thus can be kept particularly low, which benefits the efficient operation of the charging device and therefore of the fuel cell. In particular, bearing losses, the weight, and outer dimensions of the bearing can thereby be kept at a low level.

The forward curvature of the blading, wherein the impeller vanes are curved at least in the inlet region in the direction of the rotational direction in which the turbine wheel rotates during the operation of the charging device, also influences the aerodynamic size of the turbine wheel in so far as the specific turbine output according to Euler is achieved at the nominal operating point at particularly high circumferential speeds.

In comparison with impeller vanes that are aligned only radially, and under at least substantially identical outlet flow conditions, this results in an efficiency-supporting reduction of the flow deflection of the medium (waste gas), and in the achievement of a required turbine output via the higher circumferential speed at a predefined rotational speed. This can lead to an at least substantially optimal degree of reaction above the value of 0.5.

In an advantageous embodiment, the compensation element can also be acted upon, at least in some regions, by an inlet pressure that prevails in the inlet region. Thus, axial forces can be kept particularly low.

The compensation element is preferably arranged on a side of a wheel back of the turbine, which side faces away from the turbine wheel. Through the action on the compensation element, the compensation element enables the at least partial compensation of the axial forces which occur, for example, due to gas forces.

In another advantageous embodiment of the invention, the compensation element has a diameter that differs from the inlet diameter of the inlet region. Thus, the action applied onto the compensation element by the inlet pressure and/or the outlet pressure can be set appropriately in order to keep the axial forces particularly low.

Preferably, the diameter of the compensation element is greater than the inlet diameter of the inlet region. Thus, particularly high axial forces can be compensated at least partially.

In another advantageous embodiment of the invention, the compressor wheel comprises compressor vanes for compressing the additional medium, in particular air, wherein the compressor vanes are curved forwards. This means that the compressor vanes are also curved in the direction of the rotational direction in which the compressor wheel rotates during the operation of the charging device. Thereby, the additional medium can be compressed in an efficient manner.

In another advantageous embodiment, the compensation element can be acted upon in a region of the compensation element by the outlet pressure prevailing downstream of the compressor wheel, wherein a chamber is delimited by means of said region, by means of the housing part and by means of at least two sealing elements of the charging device. As a result, the actions applied onto the compensation element by the inlet pressure and the outlet pressure do not influence each other such that the axial forces can be kept particularly low. This benefits the efficient operation of the charging device.

Here, the sealing elements are supported in each case, on the one hand, on the housing part and, on the other, on the compensation element or the turbine wheel or on the rotor shaft to which the turbine wheel and/or the compensation element are/is connected in a rotationally fixed manner. As a result, the required installation space and the weight of the charging device can be kept low, which results in a particularly efficient operation.

At least one of the sealing elements is formed as a piston ring for a piston of a reciprocating piston engine. This is beneficial for the low costs of the charging device. At least one of the sealing elements can also be formed as a non-contact seal, in particular as a labyrinth seal. This results in a small required installation space and also in low weight of the charging device according to the invention.

In order to implement a particularly efficient operation of the charging device, vane inlet angles of the impeller vanes are preferably greater than 100° and less than 150°. In combination with the particularly large aerodynamic embodiment of the turbine wheel in the inlet region thereof, this results in advantageous flow conditions for the waste gas.

Further advantages, features and details of the invention arise from the following description of preferred exemplary embodiments and from the drawing. The features and feature combinations mentioned above in the description as well as the features and feature combinations specified below in the description of the figures or shown in the figures alone can be used not only in the respective stated combination, but also in other combinations or alone without departing from the scope of the invention.

### BRIEF DESCRIPTION OF THE DRAWING FIGURES

In the figures,

FIG. 1 shows a schematic longitudinal sectional view of a charging device comprising a turbine and a compressor, for illustrating axial forces that act upon a bearing of a rotor having a shaft, a turbine wheel of the turbine, and a compressor wheel of the compressor;

FIG. 2 shows a diagram for illustrating the connection between efficiency, optimal circumferential speeds at corresponding turbine inlet temperatures and turbine pressure conditions at a tip-speed ratio of 0.7 and a degree of reaction of 0.5;

FIG. 3 shows a schematic cross-sectional view of an embodiment of the turbine according to FIG. 1;

FIG. 4 shows partially a schematic sectional view of the turbine according to FIG. 3;

FIG. 5 shows a schematic longitudinal section of another embodiment of the charging device according to FIG. 1;

FIG. 6 shows a schematic diagram for illustrating forces acting upon a compressor wheel of the charging devices;

FIG. 7 shows a schematic diagram for illustrating forces acting upon the turbine wheel of the charging devices;

FIG. 8 shows partially a schematic longitudinal sectional view of another embodiment of the turbine according to the FIGS. 1 and 3;

FIG. 9 shows a schematic diagram of a fuel cell which can be supplied with compressed air by a charging device;

FIG. 10 shows a velocity triangle of a turbine wheel comprising radial blading;

FIG. 11 shows a velocity triangle of a turbine wheel comprising forward-curved blading;

FIG. 12 shows partially a schematic perspective view of a forward-curved blading of a turbine wheel;

FIG. 13 shows a diagram for illustrating the behavior of the efficiency of a turbine with the blading thereof being curved forwards.

### DETAILED DESCRIPTION

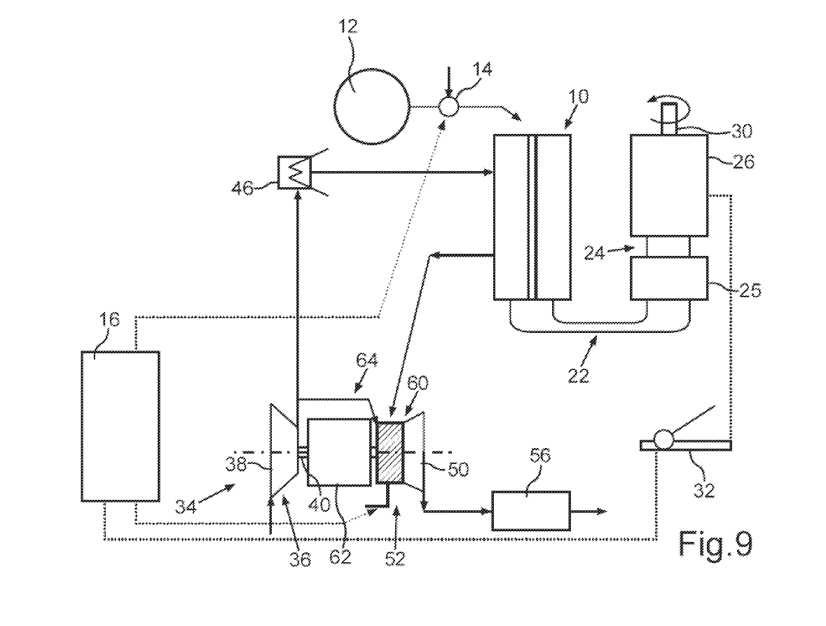

FIG. 9 shows a fuel cell 10 by means of which reaction energy of a continuously fed fuel and an oxidant can be converted into electrical energy. The fuel is present in the form of hydrogen, which is stored in a tank 12 and is fed to the fuel cell 10 via a fuel valve 14. The fuel valve 14 is controlled here by a control device 16. As an oxidant, the fuel cell 10 utilizes air from the surrounding area or oxygen as a constituent of this air, which is fed to the fuel cell.

The fuel cell 10 is connected, via lines 22, to a battery 25 that stores the produced electrical energy, which hereinafter is designated as current. The battery 25, in turn, is connected via lines 24 to an electric motor 26, which can be driven by the current stored in the battery 25. The electric motor 26 converts electrical energy into mechanical energy and delivers this energy in the form of a torque via a rotatable shaft 30. Thus, the fuel cell 10 serves for driving the electric motor 26 which, for example, can be used in a motor vehicle, in particular in a passenger car.

For adjusting, for example by a driver of the passenger car, a desired torque to be provided by the electric motor 26, an accelerator pedal 32 is provided. By actuating the accelerator pedal 32, the driver can adjust the desired torque and move the passenger car. The accelerator pedal 32 is connected to both the control device 16 and the electric motor 26 so as to adapt, by means of the fuel cell 10, the generation of current to the desired torque.

In order to implement a particularly efficient operation of the fuel cell 10, a charging device 34 is provided, which comprises a compressor 36 with a compressor wheel 38. The compressor wheel 38 is connected in a rotationally fixed manner to a shaft 40 of the charging device 34, wherein the shaft 40 is rotatably mounted in a bearing housing of the charging device 34. In this manner, the compressor wheel 38 can also be rotated and can compress the suctioned air from a pressure level, which, in the flow direction of the air, prevails upstream of the compressor wheel 38 and corresponds to the ambient pressure and is designated as compressor inlet pressure P1, to a pressure level which is higher compared thereto and prevails downstream of the compressor wheel 38 and is designated as compressor outlet pressure P2t.

Due to the compression of air by the compressor wheel 38, the air is heated. For cooling the air, the air flows to a cooling device 46, by means of which the air is cooled and subsequently fed to the fuel cell 10.

For implementing a particularly efficient operation of the fuel cell 10, a waste gas of the fuel cell 10 is fed to a turbine 52 of the charging device 34, which turbine comprises a turbine wheel 50. The turbine wheel 50 is also connected in a rotationally fixed manner to the shaft 40 and thus is rotatably mounted and can be driven by the waste gas of the fuel cell 10. The turbine 52 is an expansion turbine since in the flow direction of the waste gas of the fuel cell 10, the waste gas has a higher pressure level upstream of the turbine wheel 50, which is designated as turbine inlet pressure P3t, than downstream of the turbine wheel 50. In other words, the waste gas of the fuel cell 10 is expanded by means of the turbine 52, wherein the turbine 52 or the turbine wheel 50 utilizes the energy stored in the waste gas for driving the compressor wheel 38. The pressure of the waste gas downstream of the turbine 52 is designated as turbine outlet pressure P4.

After flowing off from the turbine wheel 40, the waste gas flows to a waste gas after-treatment device 56, which cleans the waste gas from harmful emissions. Downstream of the waste gas after-treatment device 56, the waste gas flows into the surroundings.

In order to adapt the turbine 52 to different operating points of the electric motor 26 and thus of the fuel cell 10, the turbine 52 is designed as a so-called vario turbine. This means that upstream of the turbine wheel 50, a variably adjustable guide vane cascade 60 is arranged by means of which flow conditions of the inflow of waste gas against the turbine wheel 50 can be influenced and can be adapted to different operating points of the fuel cell 10, pressure conditions of the compressor 36, and/or the like. The guide vane cascade 60 can also be controlled by the control device 16.

Furthermore, the charging device 34 comprises an additional electric motor 62, by means of which the shaft 40 and thus the compressor wheel 38 as well as the turbine wheel 50 can be driven. The electric motor 62 is required since the output provided by the turbine 53 alone is not sufficient for driving the compressor 34. This results in a very efficient operation of the fuel cell 10.

Due to the compression of the air, relatively high axial forces act upon the compressor 28 and thus on the turbine wheel 50 and also on the shaft 40 and on a bearing of the shaft 40 in the bearing housing, which axial forces put high load on the bearings and can cause an undesirable short service life of the bearing if no counter measures are taken. In order to reduce or even avoid this load and stress acting upon the bearing, the charging device 34 comprises an axial thrust compensation 64 which is schematically illustrated in FIG. 9 and by means of which the axial forces can be compensated or reduced. This axial thrust compensation 64 is explained below in greater detail in conjunction with the remaining figures.

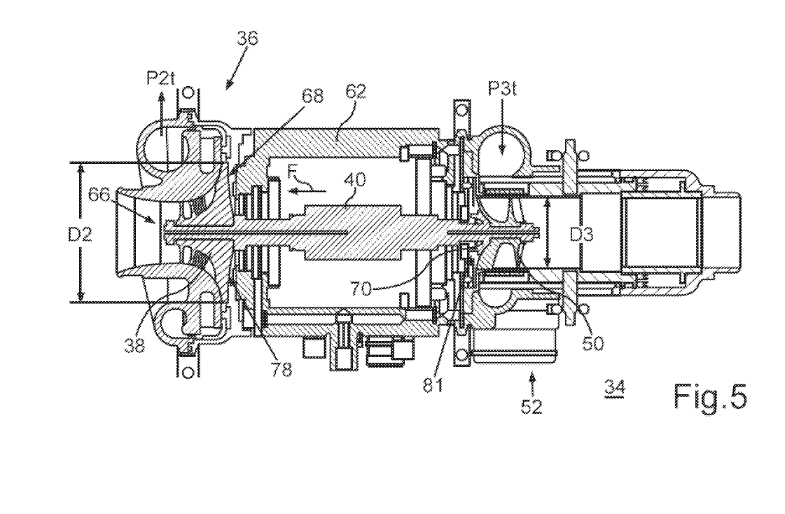

FIG. 5 shows a possible embodiment of the charging device 34 comprising the compressor 36, the additional electric motor 62 and the turbine 52 designed as an expansion turbine in the form of a vario turbine. When supplying the fuel cell 10 with compressed air, the compression of the air results in relative high axial forces which originate from the compressor wheel 38. In order not to exceed a given rotational speed limit of the additional electric motor 62, which lies, for example, in a range of 100,000 revolutions per minute, a first diameter D2 of the compressor wheel 38 is to be designed to be particularly large so as to meet corresponding demands with regard to the pressure conditions of the compressor 36 (in the flow direction of the air to be compressed, upstream and downstream of the compressor wheel 38).

Since the turbine 52 is provided in the charging device 34, this can result in a slight reduction of the axial forces, wherein the axial forces act in the direction towards a compressor inlet 66 and have to be absorbed by the bearing of the compressor wheel 38 and the turbine wheel 50 or the shaft 40. The turbine 52 or, respectively, the turbine wheel 50, which is designed for an optimal efficiency at the nominal operating point, thus at maximum output of the additional electric motor 62, is provided via the rigid coupling to the compressor 36 with the same rotational speed that is applied by the additional electric motor 62 to the shaft 40 or, respectively, the compressor wheel 38. A usual matching of the turbine wheel 50 and the compressor wheel 38 is carried out via an optimal tip-speed ratio of the turbine 52, which achieves or shall achieve the value of approximately 0.7 at the nominal operating point.

Since the temperatures of the waste gas of the fuel cell 10 at approximately 100° Celsius are relatively low, an optimal efficiency of the turbine 52 is obtained at small second diameters D₃ of a wheel inlet region via which the waste gas of the fuel cell 10 can flow against the turbine wheel 50 and can drive it. Due to this relative great difference of the diameters D₂, D3, problematic high axial forces act upon the bearing due to a merely low force component of the turbine wheel 50 acting counter to the axial forces coming from the compressor wheel 38.

The first diameter D₂ of the compressor wheel 38 can be greater than the second diameter D₃ by almost the factor two, which results in a first surface area A2 of a first wheel back 68 of the compressor wheel 38, which first surface area is greater than the second surface area A3 of a second wheel back 70 of the turbine wheel 50 by the factor four.

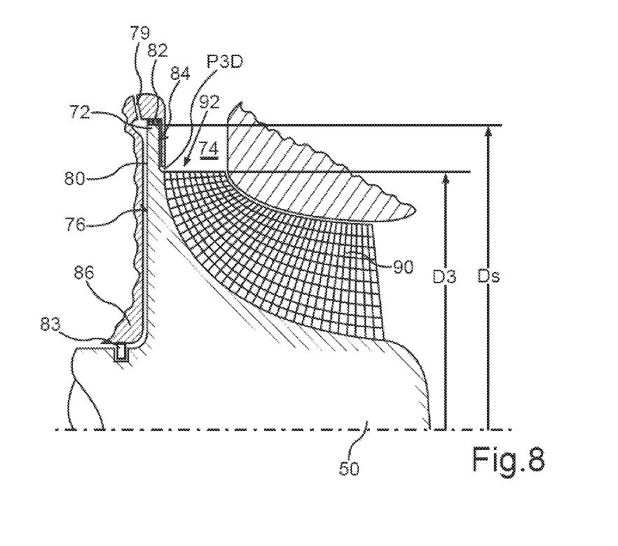

The result of this is that during the use of the fuel cell 10 in conventional passenger cars, axial forces of several 100, where applicable, 300 to 400 Newton can occur that have to be absorbed by the bearing. For example, desirable is a life span of the bearing of 6000 hours. At the same time, mounting the shaft 40 or the compressor wheel 38 and the turbine wheel 50 shall be carried out in a low-loss manner and thus with the lowest possible friction, which can be implemented, for example, by a mounting by means of at least one antifriction bearing, in particular a ball bearing. However, such ball bearings are only able to partially absorb the described high axial forces, which results in the requirement to reduce or compensate the axial forces. This is enabled by the axial thrust compensation 64 described together with the FIG. 9 and is further explained in conjunction with the FIG. 8.

As can be seen in FIG. 8, the axial thrust compensation 64 comprises a compensation disc 72 that is formed in one piece with the turbine wheel 50, as a result of which an axial thrust compensation of the axial forces that are caused by the compressor 36 and act upon the bearing is mastered by the second wheel back 70 of the turbine wheel 50. The compensation disc 72 has an outer third diameter Dₛ which, with respect to the aerodynamic second diameter D₃ which is also designated as wheel inlet diameter of a blading of the turbine wheel 50, is adjusted independently of the size and, in the present case, is configured to be greater than the second diameter D₃. Preferably, the third diameter Dₛ is a function of the axial force and is greater than the second diameter D₃.

In the case of the turbine 52, a nozzle pressure P3D at an outlet of a nozzle 74 of the turbine 52, via which nozzle the waste gas of the fuel cell 10 can flow against the turbine 50, determines substantially a pressure profile on a rear side 76 of the turbine wheel 50 or the compensation disc 72, which has a third surface area As that corresponds with the third diameter Dₛ.

A resultant of force of the turbine wheel 50 with the compensation disc 72 thus opposes a resultant of force of the compressor wheel 38. The main portion of the resultant of force of the compressor wheel 38 is determined by the static compressor outlet pressure P2t directly downstream of the compressor wheel 38, which is related to a representative mean effective pressure P2s of a compressor wheel disc 78. Analogous to this, a turbine wheel disc 81 is provided, wherein a representative mean effective pressure p3s of the turbine wheel disc 81 is related to a turbine inlet pressure p3t.

Since the turbine inlet pressure P3t has already noticeably dropped (up to 30%) due to pressure losses in pipes, heat exchangers, fuel cell stacks and/or the like, the compensation disc 72 at the turbine wheel 50 requires large dimensions due to the relatively low nozzle pressure P3D so as to be able to effect a noticeable axial force reduction.

In order to keep the third diameter Dₛ small the compressor outlet pressure P2t is advantageously tapped by means of the axial thrust compensation 64 via a channel 79 in the region of a compressor outlet or optionally a compressor collector coil, thus downstream of the compressor wheel 38, or of a compressor diffusor, and is impressed on the compensation disc 72 on the side of the turbine wheel 50 in a pressure chamber 80. The compressor outlet pressure P2t amounts to a significantly higher pressure value than the mean effective pressure P2s of the compressor wheel disc 78.

In order to let this significantly increased compressor outlet pressure P2t act upon the compensation disc 72 and for forming the pressure chamber 80, which is also designated as pressure space, sealing areas 82, 83 are provided by means of which the pressure chamber 80 is sealed. While the inner sealing area 83 can be formed as a conventional simple piston ring seal, the outer sealing area 82 on the third diameter Dₛ is advantageously formed as a non-contact seal, for example, in the form of a labyrinth seal. Potential leakages of the outer sealing area 82 are discharged via the blading of the turbine wheel 50. Thus, the pressure chamber 80 is delimited, on the one hand, by means of a region of the compensation disc 72, by means of the sealing areas 82, 83 and by means of a housing part 86 of a turbine housing of the turbine 52 and also by means of a part of a hub body of the turbine wheel 50.

On an annular surface 84, which is calculated according to the formula

(Π·((Dₛ/2)²−(D3/2)²)),

wherein the annular surface 84 is located on the side of the blading of the turbine wheel 50, the reduced nozzle pressure P3D shall, as far as possible, be applied so as to fully develop the effect of the significantly higher compressor outlet pressure P2t, which is also designated as static compensation pressure, in the pressure chamber 80.

In the case that there is no turbine 52, the compensation of the axial forces would take place analogous to the FIGS. 5 and 8 by a pure compensation disc 72, wherein then the nozzle pressure P3D would act in the range of the ambient pressure or slightly thereabove with the turbine outlet pressure P4 upon an outlet side of the compensation surface of the compensation disc 72.

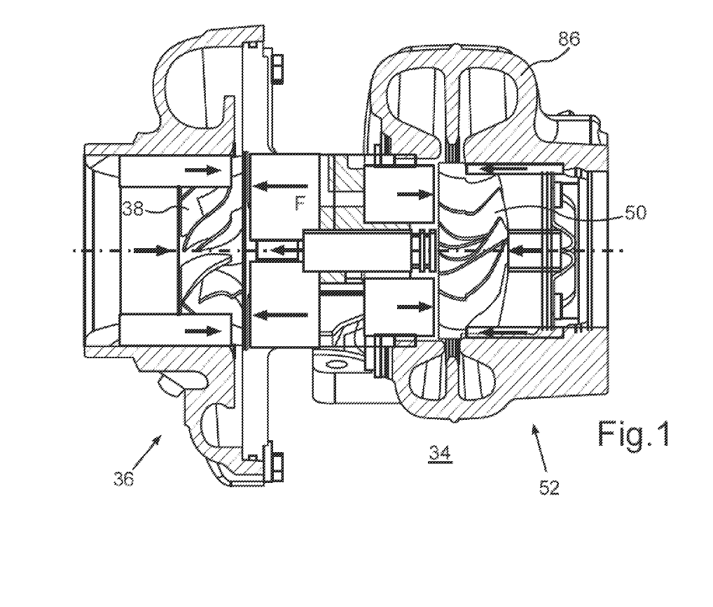

The axial forces, which act in the direction towards the compressor inlet 66, are indicated in the FIGS. 1 and 5 by a force arrow F. FIGS. 1, 6 and 7 illustrate the calculation or estimation of the axial forces. The axial forces result in particular from gas forces and effect an axial thrust that acts upon the rotor which comprises the turbine wheel 50, the compressor wheel 38 and the shaft 40. The axial thrust results in particular from axial forces which act in the direction towards the turbine outlet onto the compressor contour and the compressor wheel inlet, and which result from a compressor impulse. Furthermore, axial forces act in the direction towards the compressor inlet onto the compressor wheel. Corresponding to this, axial forces act upon the side of the turbine 52 in the direction towards the compressor inlet 66 onto the turbine wheel contour and onto the turbine wheel outlet. Moreover, axial forces act due to a turbine impulse. Axial forces act also in the direction of the turbine outlet onto the turbine wheel 50. As indicated by means of the force arrow F, the axial thrust on the compressor wheel side is significantly higher than on the turbine wheel side. This is the case because gas pressures and the wheel back surface area of the compressor wheel 38 are greater than on the side of the turbine wheel 50 if no appropriate counter measures are taken. In order to keep overall the axial thrust or the axial forces low, an at least substantially optimal aerodynamic adaptation of the turbine wheel 50 is therefore advantageous.

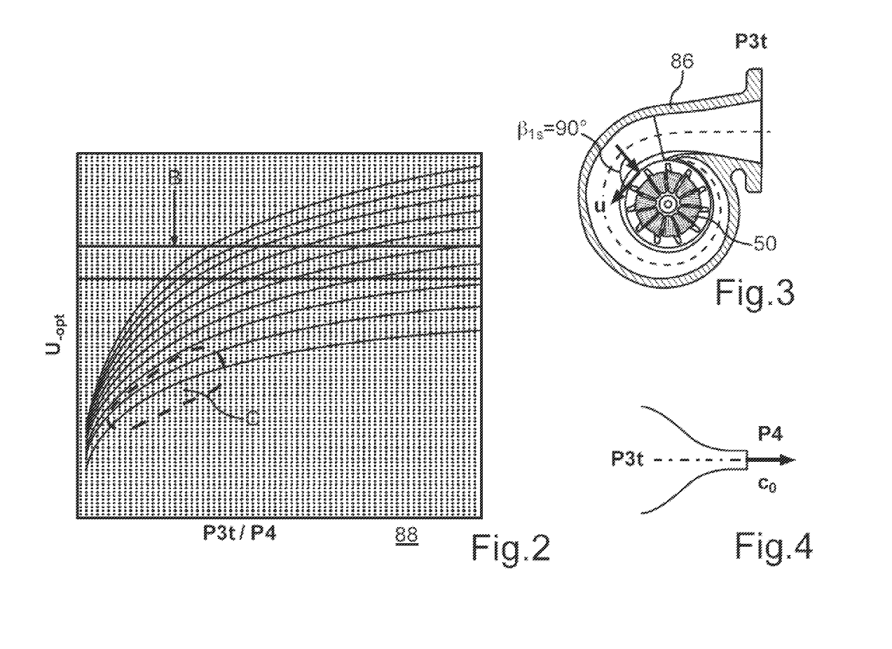

Such an aerodynamic adaptation can result in relatively small turbine wheel diameters. FIG. 2 shows by means of a diagram 88 the connection between efficiency-optimized circumferential speeds U_opt at the corresponding turbine inlet temperatures T3t and turbine pressure conditions at a value of the tip-speed ratio of 0.7 and of the degree of reaction of 0.5. The efficiency-optimized circumferential speed U_opt is obtained here at a tip-speed ratio of 0.7. In the diagram 88, the turbine inlet temperature is designated with T3t. The pressure ratio is designated with P3t/P4. Here, P3t designates the turbine inlet pressure and P4 designates the turbine outlet pressure. The tip-speed ratio results from u/c₀, wherein u designates the circumferential speed and c₀ designates the absolute speed of the waste gas. Through the optimal compressor speed for the air supply of the fuel cell 10, thus, the wheel inlet diameter (second diameter D₃) of the turbine 52 is set to small values, which is a result of the optimal circumferential speeds U_opt associated with the relatively low expansion temperatures in the range of 100° C.

FIG. 2 also shows an ultimate strength range B of the wheel which, for example, refers to the material Inconel 713 LC. Moreover, a range C is plotted in FIG. 2, which refers to the turbine 52 of the charging device 34.

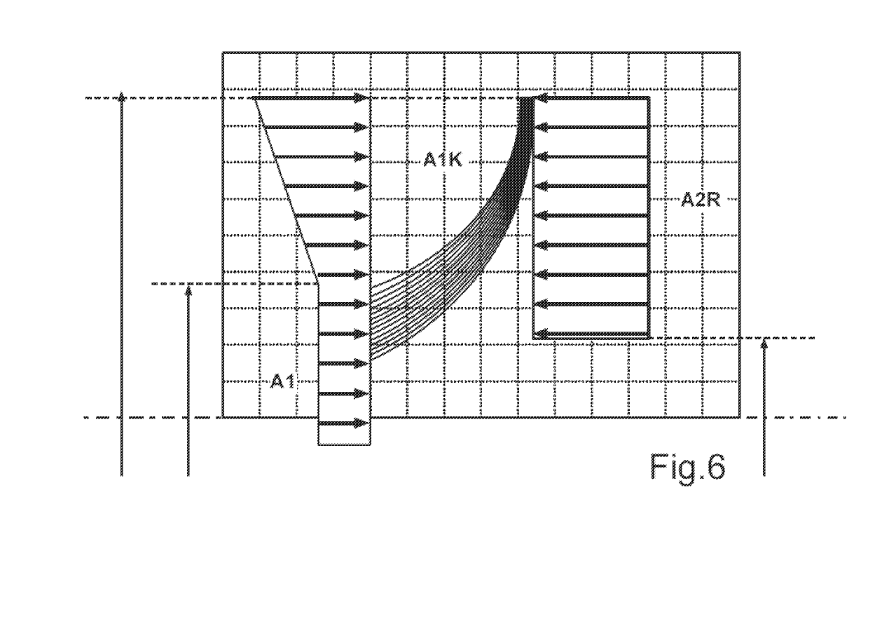

FIG. 6 shows a fourth surface area A1 and a fifth surface area A1K onto which the gas forces can act, resulting in axial forces which act upon the rotor in the direction towards the turbine outlet. FIG. 6 also shows a sixth surface area A2R which is associated with the wheel back of the compressor 38 and on which gas forces act, resulting in axial forces that act in the direction towards the compressor inlet 66.

The degree of reaction is, for example, 0.6, while the compressor inlet pressure P1 is one bar (1 bar). In the present case, the compressor outlet pressure P2T is 3.2 bar. A first pressure P2 acting on the first wheel back 68 of the compressor wheel 38 is, for example, 2.32 bar.

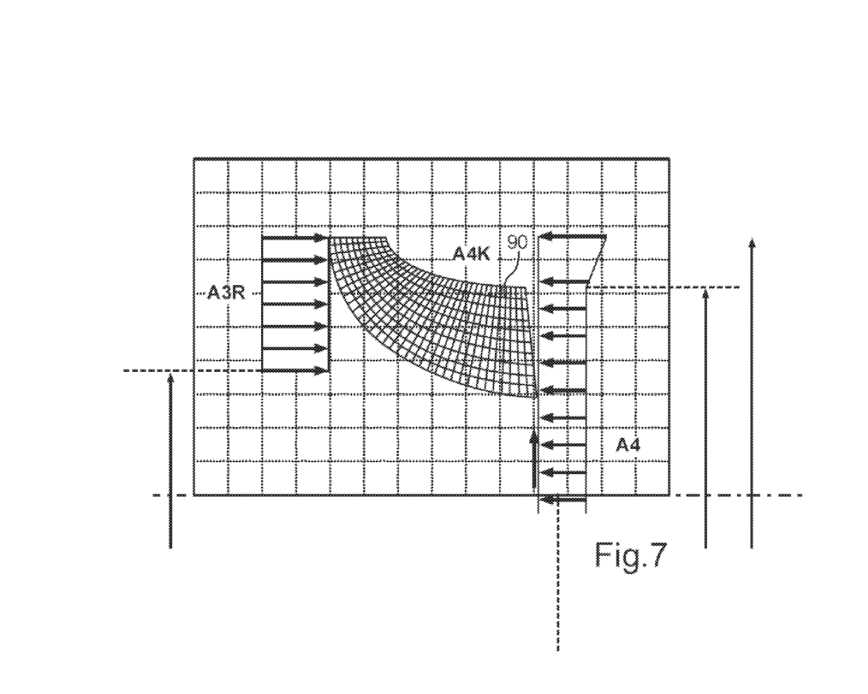

In accordance with this, FIG. 7 shows a seventh surface area A3R of the second wheel back 70 of the turbine wheel 50, wherein gas forces act upon the seventh surface area. This results in axial forces acting in the direction towards the turbine outlet. FIG. 7 also shows an eighth surface area A4K and a ninth surface area A4, wherein gas forces act upon these surface areas. This results in axial forces oriented in the direction towards the turbine inlet. The turbine inlet pressure P3t is, for example, 2.7 bar. The turbine outlet pressure is 1.0 bar. The degree of reaction is 0.5. A pressure acting upon the second wheel back 70 of the turbine wheel 50 is, for example, 1.85 bar. The axial forces amount here, for example, to 335.1 N and act in the direction towards the compressor inlet 66. By appropriately increasing the sixth surface area A3R, the axial forces can be compensated. For this purpose, the compensation disc 72 is used.

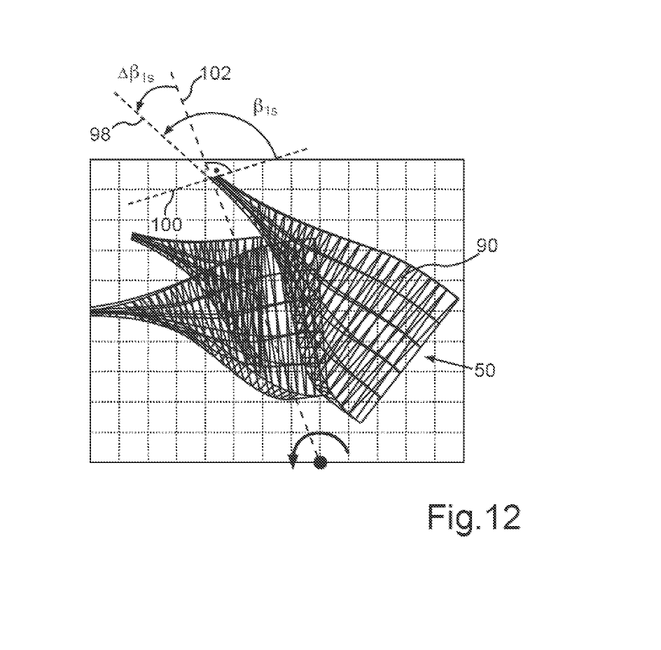

Moreover, as is in particular shown in FIG. 12, the impeller vanes 90 of the turbine wheel 50 can be curved forwards, at least in an inlet region 92 in which the waste gas flows against the turbine wheel 50. Through this, the contribution of the turbine wheel 50 to compensating the axial force is given a greater weighting in that by the forward curvature of the impeller vanes 90, the turbine wheel 50 is made larger with respect to a blading that extends only axially.

The axial extent of the compensation disc 72, i.e., its width, is preferably very small so as to keep flow losses low. Advantageously, its width is to be avoided completely, which can have an influence on the dimensioning of the vane inlet angle β₁ₛ, which is illustrated by means of FIG. 12. An advantageous and particularly large embodiment of the second diameter D₃ and the corresponding embodiment of the vane inlet angle β₁ₛ depend on the Euler relation at a targeted circumferential speed u1 and the gas velocity component cᵤ₁ desired at the nominal operating point, as can be seen in FIG. 11.

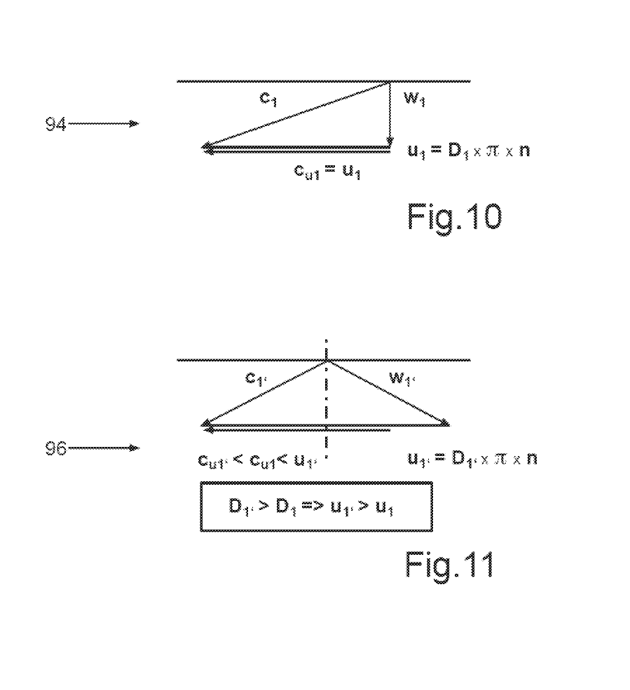

FIG. 10 shows a first velocity triangle 94, which refers to a purely radial blading of the turbine wheel 50. In contrast to this, FIG. 11 shows a second velocity triangle 96, which refers to a forward-curved blading of the turbine wheel 50, wherein the turbine wheel 50 thus comprises forward-curved impeller vanes 90 that are curved in the direction of the rotational direction in which the turbine wheel 50 rotates during the operation of the charging device 34. Advantageously, the vane inlet angle β₁ₛ is greater than 100° and less than 150°, which means a forward curvature Δ₁ₛ up to nearly 60°.

As can be seen in FIG. 12, the vane inlet angle β₁ₛ is enclosed between the inlet tangent 98 and the circumferential tangent 100 at the impeller vane 90. The forward curvature Δβ1 refers to the angle at which the impeller vane 90 is inclined with respect to a radial extent, indicated by means of a dotted line 102, with regard to its inlet tangent 98.

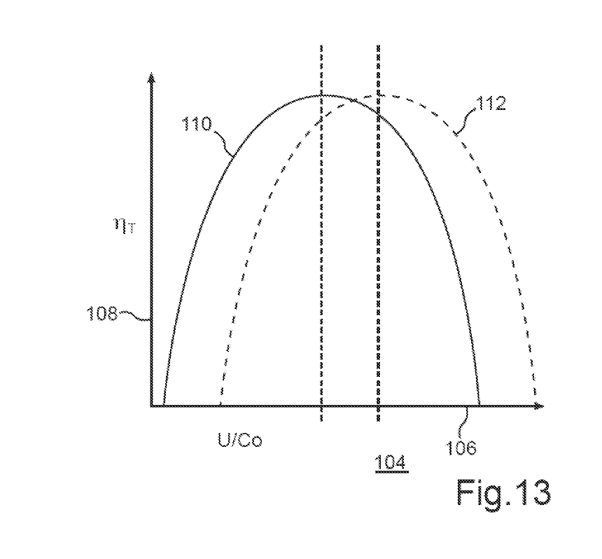

Since the turbine 52 is a so-called cold air turbine, an appropriate embodiment of the turbine wheel 50 results in stresses that are still manageable with aluminum materials. The principal efficiency behavior of the turbine wheel 50 having forward-curved impeller vanes 90 (forward-curved blading) in comparison with a purely radial extent of the blading is represented by the FIG. 13.

FIG. 13 shows a second diagram 104, on the axis of abscissa 106 of which the tip-speed ratio is plotted. On the axis of ordinate 108 of the second diagram 104, the turbine efficiency η_{T} is plotted. A first course 110 refers to the purely radially extending blading, while a second course 112 refers to the forward-curved blading of the turbine wheel 50, wherein the vane inlet angle β₁ₛ is greater than 90°. Viewed here is an at least substantially optimal degree of greater than 0.5. The efficiency optimum can be shifted via the forward curvature of the impeller vanes 90 towards higher tip-speed ratios, which can be advantageous for dimensioning the nominal operating point of the turbine 52 that is designed as an expansion turbine.

For the operating behavior of the charging device 34, the forward-curved blading is also advantageous, in addition to the advantage of the at least partial compensation of the axial forces, in many operating phases such as, for example, in non-steady run-up and deceleration phases. Here, due to the efficiency, higher tip-speed ratios are possible such that with respect to a purely radially extending blading, the ventilation tendency of the forward-curved blading is lower during the changes in rotational speed and gas throughput that are largely determined by the additional electric motor 62. In sum of the relevant run cycles, this results in an increase of efficiency of the charging device 34 comprising the turbine wheel 50, the impeller vanes 90 of which are curved forwards.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A charging device for a fuel cell, wherein the fuel cell provides electric current for driving a motor vehicle, the charging device comprising:
a radial turbine having a housing part with a receiving chamber in which a turbine wheel of the radial turbine is arranged so as to be rotatable relative to the housing part about an axis of rotation,
wherein the turbine wheel comprises impeller vanes configured so that a gaseous waste gas of the fuel cell flows against the turbine wheel in an inlet region,
wherein the impeller vanes of the turbine wheel are curved forwards in the inlet region and in a direction of a rotational direction of the turbine wheel.

12. The charging device of claim 11, further comprising:
a compensation element connected to the turbine wheel for at least partially compensating axial forces; and
a compressor wheel, which is rotatable about the axis of rotation and by means of which air fed to the fuel cell is compressed,
wherein the compensation element is configured to be acted upon at least in some regions via at least one channel by an outlet pressure that prevails in a flow direction of an additional medium to be compressed downstream of the compressor wheel.

13. The charging device of claim 12, wherein the compensation element is configured to be acted upon, at least in some regions, by an inlet pressure prevailing in the inlet region.

14. The charging device of claim 12, wherein the compensation element has a diameter that differs from an inlet diameter of the inlet region.

15. The charging device of claim 14, the diameter of the compensation element is greater than the inlet diameter of the inlet region.

16. The charging device of claim 12, wherein the compressor wheel comprises compressor vanes configured to compress the additional medium, and wherein the compressor vanes are curved forwards.

17. The charging device of claim 12, wherein the compensation element is configured to be acted upon, in a region of the compensation element, by the outlet pressure prevailing downstream of the compressor wheel, wherein a chamber is delimited by the region, the housing part and at least two sealing elements of the charging device.

18. The charging device of claim 17, wherein the at least two sealing elements are each supported on the housing part, and on the compensation element, the turbine wheel, or a shaft to which the turbine wheel, or
wherein the compensation element is connected in a rotationally fixed manner.

19. The charging device of claim 17, wherein at least one of the at least two sealing elements is a piston ring for a piston of a reciprocating piston engine or a non-contact labyrinth seal.

20. The charging device of claim 11, wherein at least one vane inlet angle of the impeller vanes is greater than 100 degrees and less than 150 degrees.
